(19) United States
(12) Patent Application Publication
(10) Pub. No.: US 2004/0116131 A1
(43) Pub. Date: Jun. 17, 2004

(54) Method and device for exchange of geographical location information between location information server and core network element

(76) Inventors: Christoph Hochrainer, Wien (AT); Heinz Reisinger, Wien (AT)

Correspondence Address: LERNER AND GREENBERG, PA, P O BOX 2480, HOLLYWOOD, FL, 33022-2480, US

(21) Appl. No.: 10/727,182

(22) Filed: Dec. 3, 2003

(30) Foreign Application Priority Data
Dec. 3, 2002 (DE) 102 56 457.4

(51) Int. Cl. H04Q 7/20

(52) U.S. Cl. 455/456.1; 455/404.2; 455/423; 455/67.11

(57) ABSTRACT

A method for optimized exchange of geographical location information between a core network element in a public telecommunication network, in particular, a mobile radio network, and a location information server unit includes, before a core network element is accessed for the exchange of location information (in particular, for reading out) a server unit implementing a series of access attempts with messages of different message types, until one access attempt has resulted in a successful exchange of information. When an access attempt has resulted in a successful exchange of information, a corresponding entry is added to stored decision information on the part of the server unit; during subsequent access to the core network element, implementation is based on the entry using the message type according to the entry.

### BACKGROUND OF THE INVENTION

Field of the Invention

The invention relates to a method for exchanging geographical location information between a core network element in a public telecommunication network, in particular, a mobile radio network, and a location information server unit using at least one message of a protocol supported by core networks of the telecommunication network, with the message type for the message used for the exchange of location information being selected on the part of the server unit. The invention also relates to a location information server unit for implementing the method.

In modern mobile networks services are being increasingly used in which the geographical location of a subscriber is called upon in the execution. Such services utilize what are referred to as location services (LCS) set up in the network according to the ETSI/3GPP standard TS 23.271, which provide geographical location data. The geographical location information generally relates to the position of a subscriber of the mobile network or that subscriber's mobile terminal. The position services taken into account in the 3GPP standard referred to above are in particular the location systems Uplink Time of Arrival (TOA), Enhanced Observed Time Difference (E-OTD) and Global Positioning System (GPS). Location information servers are provided as the central response point for location services in telecommunication networks. In a GSM network, for example, a location information server is set up in the form of a specific network node, referred to as the Mobile Location Center (MLC) (a plurality of MLCs can be provided in one GSM network). The server is, generally, associated with a specific mobile network and can, depending on any existing roaming agreements, also undertake the location of subscribers of its own network, who are roaming at the time in external networks and/or the location of subscribers of external networks, in addition to locating network subscribers in the mobile network.

Location information servers naturally have to manage a high level of message exchange with the network elements of the core network of a telecommunication network—in the case of a mobile radio network, these are the home location register and the mobile switching centers, in particular, with such message exchange taking place partly within a network, partly across networks. The core network elements of a mobile radio network communicate through the MAP protocol standardized in the ETSI/3GPP standard TS 29.002, which provides the core network elements with a limited and clearly defined set of standardized MAP messages for communication purposes. Nevertheless, the location information server is faced frequently with the problem of exchanging the most precise location information possible with core network elements, which have very different support for the associated protocols or messages and/or location services.

The geographical location information considered here (hereafter abbreviated to “location information”) can have differing levels of precision and can even vary within the network—depending on the core network elements in question. In the case of LCS-compatible location information, it can be presented in the form of geographical latitude and geographical longitude; in its “simplest” form, it corresponds to the location information used within a mobile network, which specifies the mobile radio cell and/or the mobile switching center, in the coverage area of which the mobile subscriber in question is located, and, therefore, depends on the topology of the mobile radio network.

In recent years, a series of standards for location services has been produced in the context of the 3GPP consortium; the standards TS 23.271 (functional representation of the LCS), TS 29.002 (extensions of the MAP) and TS 23.032 (UGAD—Universal Geographic Area Description) are particular examples. The core of the standardized implementation of the LCS is a gateway—referred to as a Gateway Mobile Location Center (GMLC)—which forms a bridge between centers transmitting location requests or receiving location reports (using an IP-based protocol), and the respective position determination procedure. This is executed through SS7 interfaces within the core network and radio coverage area of the network. For the core network of a mobile network, TS 23.271 and TS 29.002 have specified new MAP services, which are intended for locating mobile subscribers. The results of these services can be interpreted as (approximate) coordinates on the earth's surface taking into account the associated uncertainty data.

However the implementation and deployment of a location information server according to the standards, which is only based on these new LCS-MAP services, are not adequate for current mobile network environments. This is because in current mobile network core network infrastructures only a small proportion of the network elements support the new LCS-MAP services; the majority of the network elements tend, instead, to support only pre-standard mechanisms, namely MAP-ATI and/or SMS—SIM based methods for locating mobile subscribers, and these provide less precise location information. The environment structure becomes even more complex when core network elements from different manufacturers with different MAP implementations and/or versions are used in the network. As a result, not only is location precision non-homogenous within the network but also the MAP versions and, therefore, also the associated communication; the situation becomes even more complicated if a plurality of networks is involved—e.g., with roaming. A location information server is, then, required, which offers its clients transparent access to location information according to the prior art.

### SUMMARY OF THE INVENTION

It is accordingly an object of the invention to provide an exchange of geographical location information between location information server and core network element that overcome the hereinafore-mentioned disadvantages of the heretofore-known devices and methods of this general type and that improves the exchange of location information with a location information server—particularly the reading of the data from a core network element—so that the most precise location information possible can be transmitted depending on the network elements involved in each instance, so that in heterogeneous networks, in particular, access can be implemented in an efficient manner. “Heterogeneous network” as used here means a network with core network elements from different manufacturers and/or with a different degree of conformity with regard to implementation of the LCS standard. Also, to take subscriber roaming into account, it should be possible to process mobile networks of different standards such as GSM, GPRS, or UMTS.

With the foregoing and other objects in view, there is provided, in accordance with the invention, a method for exchanging geographical location information between a core network element in a public telecommunication network, in particular, a mobile radio network, and a location information server unit utilizing at least one message of a protocol supported by core networks of the telecommunication network, including the steps of selecting, with the server unit, a message type for the message used for the exchange of location information and before accessing a core network element for exchange of the location information, implementing a series of access attempts with messages of different message types with the server unit until one access attempt has resulted in a successful exchange of information.

A method or a location information server unit for implementing such a method, with which, before a core network element is accessed for the exchange of location information, a series of access attempts is made by the server unit with messages of different message types, until one access attempt has resulted in a successful exchange of information.

The present invention allows flexible access to core network elements, in order to obtain location information with the greatest possible precision, with the efficient method being used in each instance for the transmission of the location data in a heterogeneous mobile radio network, depending on the quality of the network, in particular, the mobile radio network.

In accordance with another mode of the invention, to reduce outlay in successive access operations, decision information is held on the part of the server unit, in which at least one message type in each instance is assigned to at least one core network element to implement the exchange of location data, with the decision data being supplemented by one entry by the server unit, when an access attempt has resulted in a successful exchange of location information—if the entry does not already exist; in this, the type of message with which access was successful is assigned to the core network element. It is expedient here if, before a core network element is accessed for the exchange of location information, the server unit checks the decision information for an entry for the core network element in question and, if such an entry exists, the location information exchange is implemented based on the message type according to the entry, or else a series of access attempts takes place with messages of different message types, until one access attempt has resulted in a successful exchange of information, and the decision information—if it does not already exist—is added on the part of the server unit.

In accordance with a further mode of the invention, it is also expedient, if an access attempt is made with messages according to the valid LCS standards and, if this is not successful, then at least one access attempt is made according to methods valid for the LCS standards, in particular, by MAP-ATI requests according to the CAMEL standard. To be able to determine the current location of a subscriber, provision can be made in a development for a short message to be sent to a mobile terminal in the network, the geographical location of which is to be determined, activating a paging operation for such a terminal.

In accordance with an added mode of the invention, the message type can also be determined, if no entry has been found for a specific core network element, such that an Application Context Negotiation is implemented with the element.

In accordance with an additional feature of the invention, expediently, the decision information can be stored in the form of a decision table, in which entries are ordered according to the core network elements.

With the objects of the invention in view, there is also provided a method for exchanging geographical location information between a core network element in a public telecommunication mobile radio network and a location information server unit utilizing at least one message of a protocol supported by core networks of the telecommunication network, including the steps of selecting, with the server unit, a message type for the message used for the exchange of location information, before accessing a core network element for exchange of the location information, implementing a series of access attempts with messages of different message types with the server unit until one access attempt has resulted in a successful exchange of information, storing decision information with the server unit, assigning, in the server unit, at least one message type to at least one core network element for implementing the exchange of the location information, when an access attempt has resulted in a successful data exchange, adding, with the server unit, one entry to the decision information if the entry does not already exist, in which information every message type, with which access was successful, is assigned to the core network element, before the core network element is accessed for the exchange of location information, checking, with the server unit, the decision information for an entry for the relevant core network element and if an entry for the relevant core network element exists, implementing the location information exchange based upon the message type according to the entry and implementing a series of access attempts with messages of different message types until one access attempt has resulted in a successful data exchange and the decision information is added on the part of the server unit if such an entry does not already exist, implementing an access attempt with messages according to the valid LCS standards and, if not successful, implementing at least one access attempt according to methods valid for the LCS standards, sending a message to a mobile terminal in the network, the geographical location of which is to be determined, and activating a paging operation for the mobile terminal as a result of the short message sent, if no entry has been found for a specific core network element, implementing an application context negotiation with the element and determining a message type based upon the application context negotiation and storing the decision information in the form of a decision table in which entries are ordered based upon the core network elements.

With the objects of the invention in view, there is also provided a method for exchanging geographical location information, including the steps of providing a core network element in a public telecommunication network having core networks, providing a location information server unit, and exchanging geographical location information between the core network element and the location information server unit utilizing at least one message of a protocol supported by the core networks by selecting, with the server unit, a message type for the message used for the exchange of the location information and before accessing a core network element for exchange of the location information, implementing a series of access attempts with messages of different message types with the server unit until one access attempt has resulted in a successful exchange of information.

With the objects of the invention in view, in a public telecommunication network having core networks and a core network element, there is also provided a method for exchanging geographical location information between the core network element and a location information server unit utilizing at least one message of a protocol supported by the core networks, including the steps of selecting, with the server unit, a message type for the message used for the exchange of location information and, before accessing a core network element for exchange of the location information, implementing a series of access attempts with messages of different message types with the server unit until one access attempt has resulted in a successful exchange of information.

With the objects of the invention in view, in a public telecommunication network having core networks, a core network element, and a location information server unit utilizing at least one message of a protocol supported by the core networks, there is also provided a location server including a location information server unit for exchanging geographical location information between the core network element in the network and the location information server unit, the server unit being programmed to select a message type for the message used for the exchange of location information and being programmed to implement, before accessing the core network element for exchange of the location information, a series of access attempts with messages of different message types with the server unit until one access attempt has resulted in a successful exchange of information.

With the objects of the invention in view, in a public telecommunication network having core networks, a core network element, and a location information server unit utilizing at least one message of a protocol supported by the core networks, there is also provided a location server including a location information server unit for exchanging geographical location information between the core network element in the network and the location information server unit, the server unit being adapted to select a message type for the message used for the exchange of location information and to implement, before accessing the core network element for exchange of the location information, a series of access attempts with messages of different message types with the server unit until one access attempt has resulted in a successful exchange of information.

Other features that are considered as characteristic for the invention are set forth in the appended claims.

Although the invention is illustrated and described herein as embodied in an exchange of geographical location information between location information server and core network element, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a block circuit diagram of a GSM network with a GMLC according to the invention; and

FIG. 2 is a block flow diagram for the implementation of access by the GMLC in FIG. 1.

### DESCRIPTION OF THE PREFERRED EMBODIMENTS

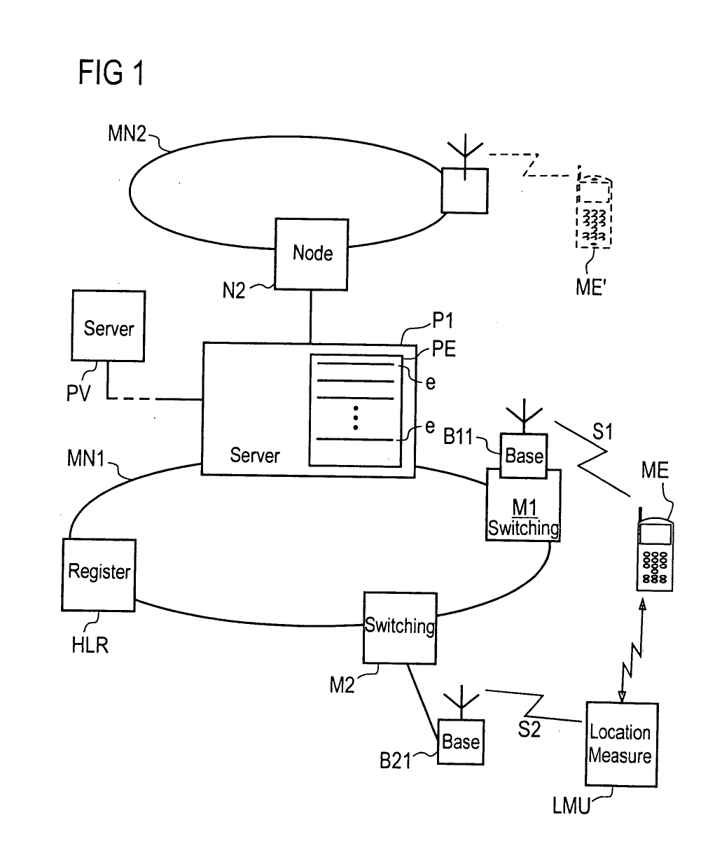

Referring now to the figures of the drawings in detail and first, particularly to FIG. 1 thereof, there is shown an example of a heterogeneous GSM network MN1, to which a mobile subscriber is connected through their mobile terminal ME through a radio interface S1 to a base station B11. Naturally, a plurality of subscribers is connected generally to the network but, for the sake of clarity, the subscribers and the associated base stations and further network centers are not shown here; instead, FIG. 1 shows only those network components that are necessary for an understanding of the invention. Such necessary components include, in particular, a home location register HLR in the known manner, which is used for central administration of network subscriber data, and mobile switching centers M1, M2 (MSC). In the topology shown, the switching center M1 serves the area of coverage of the base station B11 associated with the subscriber ME. The home location register HLR and mobile switching centers M1, M2 are network nodes of the core network of the network MN1; as mentioned above, it can be assumed generally that the individual elements of the core network originate from different manufacturers and/or achieve complete implementation of the LCS standard in a different manner.

The geographical location of the mobile subscriber or that subscriber's terminal ME is determined by a location measurement unit LMU, for example, by radio measurements based on the TOA location system. The location data identified by the location measurement unit LMU is fed into the network MN1, e.g., according to TS 23.271 through a radio interface S2, by which the unit LMU is connected like a mobile end subscriber through a base station B21 to the network by a mobile switching center M2.

A location data server (GMLC) P1 is provided in the network MN1 for processing the location data and location data server P1 communicates with the elements HLR, M1, M2 of the core network of the network MN1. The GMLC P1 can also communicate with core network elements in other networks, e.g., with the network node N2 of a second mobile radio network MN2, in the area of coverage of which the mobile subscriber—shown with a broken line as terminal ME′ in FIG. 1—may be temporarily located.

According to the invention, the GMLC P1 dynamically sets up a decision table PE, in which information is stored, as to how a specific core network element HLR, M1, M2, N2 can be accessed. The decision table PE contains, for example, a list of entries e, in which there is an entry for every core network element stating which messages or protocols were successful in a previous access operation. The decision table PE can, as shown in FIG. 1, itself be stored in the location information server unit or according to a variant that is not shown in a storage device separate from the server unit. If the GMLC P1 is to access a hitherto unknown partner network element—i.e., one not entered in the decision table PE—the capabilities of the unknown network element are determined first. A first assessment of the capabilities of the partner network element can be obtained during what is referred to as the Application Context Negotiation (ACN), in which—in a MAP standard method according to the 3GPP standards—the GMLC P1 sets up a MAP dialog with the partner, whereby the resulting application context specifies the version of a MAP message or a MAP service, respectively, that is implemented by the partner network element.

Frequently, detailed information about the capabilities of a partner can only by determined using trial and error strategies because a partner has, possibly, not implemented the ACN in full and simply ignores MAP messages that are not supported. Therefore, the GMLC P1 first tries to address the partner through the standard MAP services for location requests (messages MAP-SEND-ROUTING-INFO-FOR-LCS or MAP-PROVIDE-SUBSCRIBER-LOCATION). If the GMLC P1 receives a reply message corresponding to this in the course of the ACN, the relevant partner network element (or network elements, if a plurality of partner network elements was involved) is entered in the decision table as LCS standard compliant.

If, however, an error report is returned, from which it can be seen that the addressed core network element does not support the LCS-MAP service, the GMLC P1 updates the decision table accordingly and the GMLC P1 accepts the MAP services for pre-standard location (MAP-ANY-TIME-INTERROGATION to the home location register), with enforced paging being executed beforehand if necessary. This enforced paging can, for example, be carried out by sending an empty short message (of the short message service SMS of the GSM networks) to the subscriber. If the error report is not specific enough or is timed out, an internal counter is incremented for the network element in question and the same MAP service is repeated. If a selectable number of successive failed attempts is reached, this means that the GMLC P1 must attempt a pre-standard location request; a corresponding entry is added to the decision table.

The process described can, under certain circumstances, take up time and resources but it only takes place with the first access to a network element in each instance by the GMLC P1. With a subsequent message exchange, the GMLC reads the corresponding entry in the internal decision table and immediately addresses the appropriate MAP service.

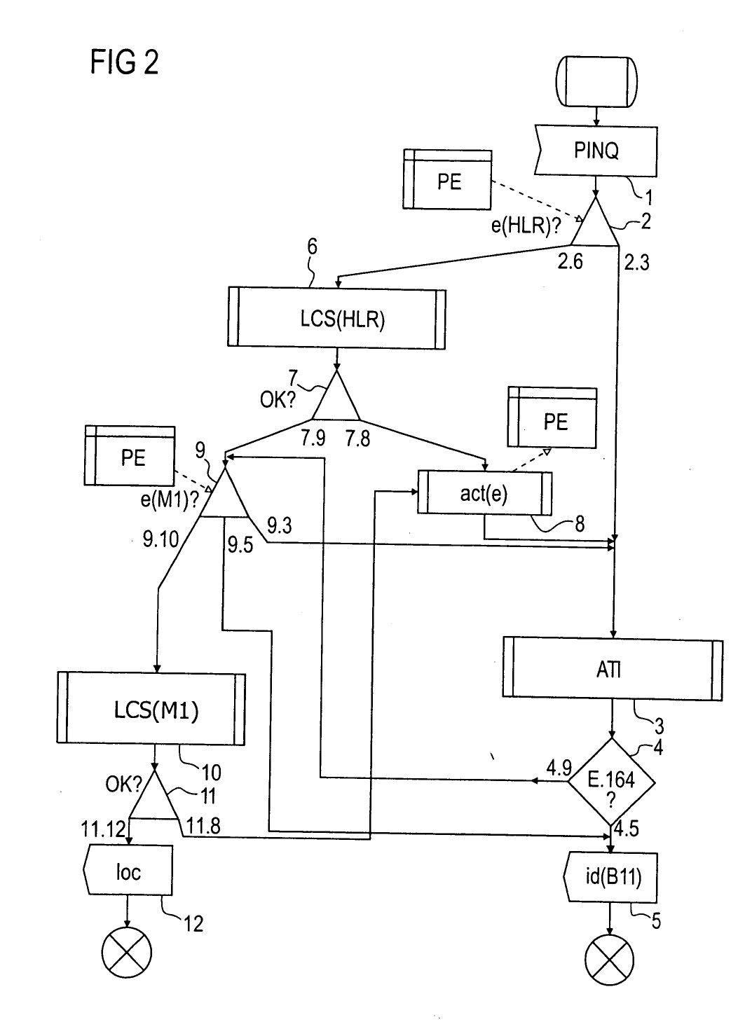

FIG. 2 shows a flow diagram, of what is executed on the part of the GMLC P1 according to the invention during processing of a location request as set out above. The process is started based upon receipt 1 of a location request PINQ. The request PINQ originates, for example, from an external server PV, which is connected to the GMLC P1, for example, through the Internet or a different communication network and on which an application is running, which requires the geographical location of the network subscriber ME; an example of such an application is a location-related service, with which the subscriber ME requests the location of a restaurant, ATM, etc. nearby.

The GMLC now implements a check 2 of the decision information in the decision table PE, for an entry relating to the relevant location register, i.e., in the network MN1 the home location register HLR. If such an entry shows that the home location register HLR does not support the LCS standard (branch 2.3 to stage 3), an ATI request is implemented, i.e., by an ANY-TIME-INTERROGATION message of the MAP, to the home location register, in order to determine the mobile radio cell or mobile switching center M1, in the area of coverage of which the requested subscriber ME is located. In order to be able to determine the current location, if required, a paging operation can be enforced by sending an empty short message through the known SMS service of the GSM network.

After the ATI inquiry, it is determined (in decision 4) whether or not an E.164 number is available for the current mobile switching center of the subscriber. If the E.164 number can be determined, next, a verification is conducted as to whether or not the switching center M1 can be addressed in an LCS-compliant manner, which corresponds to a branch 4.9 to the check 9 considered below.

However, if the E.164 number is not available, it is not possible to send an LCS-compliant geographical location, so branch 4.5 is taken to stage 5, in which the identification number id(B11) of the mobile radio cell is sent to the requesting center, i.e., the external server PV, instead of LCS location information.

If, however, in check 2 an entry e(HLR) is found, as a result of which the home location register HLR can process an LCS-compliant request or if no entry can generally be found for this network element, the GMLC proceeds through branch 2.6 to stage 6. An LCS-standard request is implemented with the home location register to determine the mobile switching center responsible for the actual location. Any errors occurring here result in the decision 7: if there are errors, which show that the register HLR cannot process the request in an LCS-compliant manner,—branch 7.8- in stage 8 the decision table PE is updated by the addition or correction act(e) of a corresponding entry e(HLR) for the home location register HLR and the process continues with stage 3.

In the event of LCS-compliance 7.9, however, a successful data exchange takes place between the GMLC and the home location register HLR, with the GMLC obtaining the E.164 number of the mobile switching center M1 responsible for the subscriber ME sought.

In the next check 9, an entry e(M1) is sought to establish whether or not the switching center M1 is LCS-compliant: a positive entry corresponds to path 9.10 as set forth below; processing is identical if there is no entry at all. If the decision information exists that the switching center is not LCS-compliant, a check is carried out to establish whether or not an ATI message (see the discussion on stage 3 above) still has to be sent or has already been sent. In the first instance, path 9.3 is taken to the ATI request; in the latter instance—if no suitable E.164 number exists from the ATI request—the process is terminated after path 9.5 with the sending 5 of the identification number id(B11) of the mobile radio cell. If the E.164 number exists, after path 9.10 the process continues with stage 10.

In stage 10 the GMLC implements an LCS standard request to the relevant mobile switching center or mobile radio cell to determine the position of the subscriber ME. As above for the home location register (stages 6 and 7) a decision is now made based upon any errors 11, whether or not—in the event of no errors 11.12—LCS-compliant sending 12 of the location information loc takes place. If there are errors that show that the partner element does not have control of the LCS standard, the process continues through branch 11.8 with the corresponding update 8 of the decision table and the subsequent stages according to the above.

In the case of error-free LCS-compliance as discussed above, in stage 12 the server PV is sent the geographical location information loc it requested. Provision can also be made (not shown as a separate stage in FIG. 2) for any missing entries for the home location register HLR or the mobile switching center M1 to be added to the decision table PE. This completes the procedure for processing the location request PINQ.

A mechanism should also be provided so that the GMLC P1 can identify when a core network element has been extended in respect of the LCS. For such a purpose, provision can be made, for example, for the entries in the decision table—or, generally, the table as a whole—to be deleted at regular intervals, e.g., after the end of a configurable period or after implementation of a configurable number of access operations in respect of the relevant network element. An entry thus deleted is, then, recreated during the next access operation, in which the method described above is implemented again.

The invention can be used in heterogeneous core networks, in particular, in GSM/UMTS networks with network centers produced by different manufacturers. It allows access to location information for mobile subscribers regardless of the capabilities of the diverse core network elements in respect of location services. By collecting information relating to the partner network element in a decision table, it becomes possible to make the decision, which is a difficult one, of how to exchange geographical location information with a network element with the least possible amount of administrative outlay or effort.

We claim:

1. A method for exchanging geographical location information between a core network element in a public telecommunication network and a location information server unit utilizing at least one message of a protocol supported by core networks of the telecommunication network, which comprises:
selecting, with the server unit, a message type for the message used for the exchange of location information; and
before accessing a core network element for exchange of the location information, implementing a series of access attempts with messages of different message types with the server unit until one access attempt has resulted in a successful exchange of information.

2. The method according to claim 1, wherein the public telecommunication network is a mobile radio network.

3. The method according to claim 1, which further comprises:
storing decision information with the server unit;
assigning, in the server unit, at least one message type to at least one core network element for implementing the exchange of the location information; and
when an access attempt has resulted in a successful data exchange, adding, with the server unit, one entry to the decision information if the entry does not already exist, in which information every message type, with which access was successful, is assigned to the core network element.

4. The method according to claim 3, which further comprises, before the core network element is accessed for the exchange of location information, checking, with the server unit, the decision information for an entry for the relevant core network element and:
if an entry for the relevant core network element exists, implementing the location information exchange based upon the message type according to the entry; and
implementing a series of access attempts with messages of different message types until one access attempt has resulted in a successful data exchange and the decision information is added on the part of the server unit if such an entry does not already exist.

5. The method according to claim 1, which further comprises implementing an access attempt with messages according to the valid LCS standards and, if not successful, implementing at least one access attempt according to methods valid for the LCS standards.

6. The method according to claim 1, which further comprises implementing an access attempt with messages according to the valid LCS standards and, if not successful, implementing at least one access attempt by MAP-ATI requests.

7. The method according to claim 5, which further comprises sending a short message to a mobile terminal in the network, the geographical location of which is to be determined, and activating a paging operation for the mobile terminal as a result of the short message sent.

8. The method according to claim 6, which further comprises sending a short message to a mobile terminal in the network, the geographical location of which is to be determined, and activating a paging operation for the mobile terminal as a result of the short message sent.

9. The method according to claim 1, which further comprises, if no entry has been found for a specific core network element, implementing an application context negotiation with the element and determining a message type based upon the application context negotiation.

10. The method according to claim 4, which further comprises, if no entry has been found for a specific core network element, implementing an application context negotiation with the element and determining a message type based upon the application context negotiation.

11. The method according to claim 3, which further comprises storing the decision information in the form of a decision table in which entries are ordered based upon the core network elements.

12. A method for exchanging geographical location information between a core network element in a public telecommunication mobile radio network and a location information server unit utilizing at least one message of a protocol supported by core networks of the telecommunication network, which comprises:
selecting, with the server unit, a message type for the message used for the exchange of location information;
before accessing a core network element for exchange of the location information, implementing a series of access attempts with messages of different message types with the server unit until one access attempt has resulted in a successful exchange of information;
storing decision information with the server unit;
assigning, in the server unit, at least one message type to at least one core network element for implementing the exchange of the location information;
when an access attempt has resulted in a successful data exchange, adding, with the server unit, one entry to the decision information if the entry does not already exist, in which information every message type, with which access was successful, is assigned to the core network element;
before the core network element is accessed for the exchange of location information, checking, with the server unit, the decision information for an entry for the relevant core network element and:
if an entry for the relevant core network element exists, implementing the location information exchange based upon the message type according to the entry; and
implementing a series of access attempts with messages of different message types until one access attempt has resulted in a successful data exchange and the decision information is added on the part of the server unit if such an entry does not already exist;
implementing an access attempt with messages according to the valid LCS standards and, if not successful, implementing at least one access attempt according to methods valid for the LCS standards;
sending a message to a mobile terminal in the network, the geographical location of which is to be determined, and activating a paging operation for the mobile terminal as a result of the short message sent;
if no entry has been found for a specific core network element, implementing an application context negotiation with the element and determining a message type based upon the application context negotiation; and
storing the decision information in the form of a decision table in which entries are ordered based upon the core network elements.

13. A method for exchanging geographical location information, which comprises:
providing a core network element in a public telecommunication network having core networks;
providing a location information server unit; and
exchanging geographical location information between the core network element and the location information server unit utilizing at least one message of a protocol supported by the core networks by:
selecting, with the server unit, a message type for the message used for the exchange of the location information; and
before accessing a core network element for exchange of the location information, implementing a series of access attempts with messages of different message types with the server unit until one access attempt has resulted in a successful exchange of information.

14. In a public telecommunication network having core networks and a core network element, a method for exchanging geographical location information between the core network element and a location information server unit utilizing at least one message of a protocol supported by the core networks, which comprises:
selecting, with the server unit, a message type for the message used for the exchange of location information; and
before accessing a core network element for exchange of the location information, implementing a series of access attempts with messages of different message types with the server unit until one access attempt has resulted in a successful exchange of information.

15. In a public telecommunication network having core networks, a core network element, and a location information server unit utilizing at least one message of a protocol supported by the core networks, comprising:
a location information server unit for exchanging geographical location information between the core network element in the network and the location information server unit, said server unit being programmed to select a message type for the message used for the exchange of location information and being programmed to implement, before accessing the core network element for exchange of the location information, a series of access attempts with messages of different message types with said server unit until one access attempt has resulted in a successful exchange of information.

16. In a public telecommunication network having core networks, a core network element, and a location information server unit utilizing at least one message of a protocol supported by the core networks, comprising:
a location information server unit for exchanging geographical location information between the core network element in the network and the location information server unit, said server unit being adapted to select a message type for the message used for the exchange of location information and to implement, before accessing the core network element for exchange of the location information, a series of access attempts with messages of different message types with said server unit until one access attempt has resulted in a successful exchange of information.
